(19) United States
(12) Patent Application Publication
(10) Pub. No.: US 2008/0095280 A1
(43) Pub. Date: Apr. 24, 2008

(54) Correlation value calculation method and correlator using the same

(75) Inventor: Hiroji Akahori, Tokyo (JP)

Correspondence Address: NIXON PEABODY, LLP, 401 9TH STREET, NW, SUITE 900, WASHINGTON, DC, 20004-2128, US

(73) Assignee: OKI ELECTRIC INDUSTRY CO., LTD., Tokyo (JP)

(21) Appl. No.: 11/896,525

(22) Filed: Sep. 4, 2007

(30) Foreign Application Priority Data
Oct. 23, 2006 (JP) 2006-287153

(51) Int. Cl. H04J 11/00; H04K 1/10; H04L 27/06

(52) U.S. Cl. 375/343; 370/210; 375/260; 375/344

(57) ABSTRACT

Object:

Even in the case where a receiving signal including a long delayed path having an equivalent power are received, deterioration of the receiving characteristics caused by inter symbol interference is reduced by reducing the variation of the maximum correlation time location and stabilizing the FFT time synchronization.

Solution:

By correlation calculation method of the correaltor 20, the receiving signal S19 is inputted, three correlation values having different time locations from each other are calculated by the delay circuits 21-2-21-5, the multiplying circuits 22-1-22-3, and the integration circuit 23-1-23-3, the three correlation values thereof are added by the adding circuit 24, and the above adding result is outputted as one correlation value. Consequently, since a strong correlation appears in the midpoint between the main arriving path and the long-delayed path when the long-delayed path having the equivalent power to the main arriving path exists, jitter of the time synchronization thereof can be restrained.

### BACKGROUND OF THE INVENTION

1. Field of the Invention

The present invention relates to a method for calculating correlation values used for time synchronization for generating FFT input (Fast Fourier Transform) signals provided a FFT demodulation unit of receiving signals modulated by OFDM (Orthogonal Frequency Division Multiplex) modulation method, and a correlator for calculating the above correlation value for FFT time synchronization.

This is a counterpart of Japanese patent application Serial Number 287153/2006, filed on Oct. 23, 2006, the subject matter of which is incorporated herein by reference.

2. Description of the Related Art

Conventionally, OFDM method transmitting simultaneously a plural of orthogonal sub carriers (signal carrier) is applicable to various applications such as digital terrestrial TV broadcasting system (hereinafter referred to as only “digital terrestrial broadcasting”), for example, as described in the following patent documents.

### Patent document 1: Japanese Patent Kokai Number H10-327122.

FIG. 6 is a view of a diagram of the transmitting signal frame configuration of the conventional OFDM method described in the above patent document.

Each of transmitting symbols SB consist of a guard interval (referred to as “cyclic prefix”, too) GI and a valid OFDM symbol (hereinafter referred to as “effective symbol”) S. The guard symbol GI is generated by extracting a latter part Sa of time waveform of the effective symbol S and copies the extracted part to the head part. Since OFDM uses a plural of cyclic waveforms composed by cyclic waveforms, the anti-multi-path characteristics thereof can be improved by adding the guard interval GI of a copy of a part of OFDM modulation waveform as repeated waveform.

In other words, when a distortion or multi-path in the transmission path in the digital transmission using OFDM method, an inter symbol interference (hereinafter referred to as “ISI”) arises in the demodulated signal. Consequently, the error rate thereof is deteriorated. To solve the above problem, at the sacrifice of a part of the sending energy (sending power), a guard interval GI for absorbing the ISI as an invalid buffer data part is included before the effective symbol S of the original sending data, using the latter part (having a length of from one severalth to several one-tenths of the whole effective symbol length) Sa of the above effective symbol S. When the aforementioned guard interval GI is included therein, a reliable receiving is possible without ISI, on condition that the delay time is shorter than the length of the guard interval GI even if a delayed receiving wave reflected from obstacles exists except the directly-receiving wave.

When the above mentioned sending data having the above-mentioned configuration is sent to the receiving side, since the delay can be neglected by ignoring the information of the guard interval GI on condition that the delay is within the period of the guard interval GI even if only some of the carriers is delayed, a errorless receiving becomes possible. Especially, the data of the latter part Sa of the effective symbol S is copied to the guard interval GI, therefore, the information cannot be lost even when some of the carriers is delayed.

FIG. 7 is a view of general configuration diagram of the conventional OFDM method demodulator described in the above patent document 1, etc.

The above OFDM method demodulator includes the frequency transformation unit 1 for inputting the receiving signal Sin, and the analog/digital (hereinafter referred to as “A/D”) conversion unit 2, the guard interval removing unit 3, the FET unit 4, parallel/serial (hereinafter referred to as “P/S”) conversion unit 5, and the demodulating unit 6, etc. are connected in tandem to the output side of the frequency transformation unit 1. The correlator 10 for FFT time synchronization is connected to the output side of the A/D conversion unit 2, and the output side of the above correlator 10 is connected to the guard-interval removing unit 3, the FFT unit 4, and the P/S conversion unit 5.

In a demodulator having the above configuration, when an OFDM-modulated transmitting signal shown in FIG. 6 is processed with signal processing such as filtering, etc., and is inputted to the frequency transformation unit 2 as the receiving signal Sin, the above receiving signal Sin is transformed to the corresponding analog base-band signal S1 by the frequency transformation unit 2. The transformed digital base-band signal S1 is sampled by the A/D conversion unit 2 and is transformed to the digital base-band signal (I signal and Q signal) S2, and is provided the guard-interval removing unit 3 and the correlator 10.

The correlator 10 detects the point (time location) having the maximum of the correlation peak by delaying the digital base-band signal S2 and correlating between the above delayed signal and the signal before being delayed using integral and addition processing. Subsequently, the correlator 10 outputs the correlation output signal S10 of the above detecting result and provides the guard-interval removing unit 3, the FFT unit 4, and the P/S conversion unit 5 with the above correlation output signal.

The guard-interval removing unit 3 detects the effective symbol S period by using the maximum point (time location) of the above correlation peak as the symbol synchronization location, based on the correlation output signal S10, and removes the guard-interval GI to extract the effective symbol S. The above extracted effective symbol S is processed with Fast Fourier Transform and is transformed to the parallel receiving data corresponding to each of the sub carriers by the FFT unit 4. The above transformed parallel receiving data is converted to the serial receiving data (complex symbol data) S5 by the P/S conversion unit 5.

The above converted serial receiving data S5 is processed with the processing of wave equalization for adjusting the transmission channel characteristics, QAM (Quadrature Amplitude Modulation) mapping for detecting the amplitude and phase information, torellis demodulation, and error correction, etc. by the demodulation unit 6, and is outputted as the demodulated data Sout.

### SUMMARY OF THE INVENTION

### Problem to be Solved:

However, the conventional correlator 10 of FIG. 7 has the following problem. FIG. 8-10 are views of explanatory diagrams of the conventional correlator 10. More specifically, FIG. 8 is a view of diagram showing the relationship between the correlation window and the receiving signal of FIG. 7. FIG. 9 is a view of a diagram showing an example of the correlation output signal S10 of FIG. 7 in the case where only one path of the main arriving path (S2) is received. FIG. 10 is a view of a diagram showing an example of the correlation output signal S10 of FIG. 7 in the case where two paths of the main arriving path (S2) and the long-delayed path (S2-1: the receiving signal Sin delayed for long time by reflection, etc.) having the equivalent power are received.

FIG. 8 shows the digital base-band signal S2 of the main arriving path, the digital base-band signal S2-1 of the long-delayed path, the signal (S2+S2-1) of an addition result between the signal S2 and the signal S2-1. The conventional correlator 10 is configured to autocorrelate the receiving signal delayed for the length of the guard interval GI, that is, is configured to autocorrelate the receiving signal having the length of the guard interval GI by delaying for the length of the effective symbol. The time synchronization is done by detecting the time location having the maximum correlation value (=power P) of the output of the correlator during the OFDM symbol period by the correaltor 10 and determining the window location (correlation windows 11, 12) of the FFT input, based on the above time location.

As shown in FIG. 9, since the correaltion output signal S10 of the correlator 10 have the strongest correlation (that is, the maximum powers P1-1, P1-2) at the time location of the main arriving path (S2) in the case of one-path receiving, the reliable receiving is possible. However, as shown in FIG. 10, in the case of two-path receiving, strong correlations (that is, the maximum powers P1-1, P2-1, and P1-2, P2-2) arise at each of the time locations of the main arriving path (S2) and the long-delayed path (S2-1), and then a track of the correlation output signal S10 (=S2+S2-1) becomes a table shape having two peaks located in the interval of two-path delay time. In a real communication situation, since the height of the above two peaks (powers P1-1, P2-1, and P2-1, P2-2) varies by influence of waveforms or interference power components of the OFDM modulated signal, respectively, the maximum correlation location traverses between the two time locations having the time interval of the long delay time, in the case where the time synchronization of the FFT input signal is acquired using the above correlation output signal S10. Consequently, the time synchronization becomes unstable, and then a problem arises that ISI occurs and the receiving characteristics are deteriorated.

### Solution:

According to a correlation calculation method of the present invention, a plural of the correlation values of different time locations are calculated by delaying a OFDM modulated receiving signal having a effective symbol added by a guard interval, and a correlation output signal for FFT time synchronization is generated by adding the above plural of correlation values each other.

The correlator of the present invention includes a correlation-value calculator for calculating a plural of correlation values of different time locations by delaying the OFDM modulated receiving signal having the effective symbol added by the guard interval, and an adder for adding the above plural of correlation values calculated by the above correlation-value calculator and outputting a correlation output signal for FFT time synchronization.

### EFFECT OF THE INVENTION

According to the correlation calculation method and the correlator using the method thereof of the present invention, since the correlation output signal of, for example, a table shape having a projected center part is generated by delaying and adding the OFDM symbol, the above correlation calculation method and the correlator is effective, especially, in the case where the number of the OFDM signals is one or two. Consequently, even when during a receiving signal including a long-delayed path having the equivalent power is being received, the variation of the maximum correlation time locations is small and the FFT time synchronization is stable, therefore, the receiving characteristics deterioration caused by ISI can be reduced.

### BRIEF DESCRIPTION OF THE DRAWINGS

FIG. 1: A view of a general configuration diagram of a correlator for FFT time synchronization according to the first embodiment of the present invention.

FIG. 2: A view of a conceptual diagram of the correlation output signal S24 of FIG. 1.

FIG. 3: A view of a general configuration diagram of a correlator for FFT time synchronization according to the second embodiment of the present invention.

FIG. 4: A view of a general configuration diagram of a correlator for FFT time synchronization according to the third embodiment of the present invention.

FIG. 5: A view of a general configuration diagram of a correlator for FFT time synchronization according to the fourth embodiment of the present invention.

FIG. 6: A view of a diagram of the transmitting-signal frame-configuration of the conventional OFDM method.

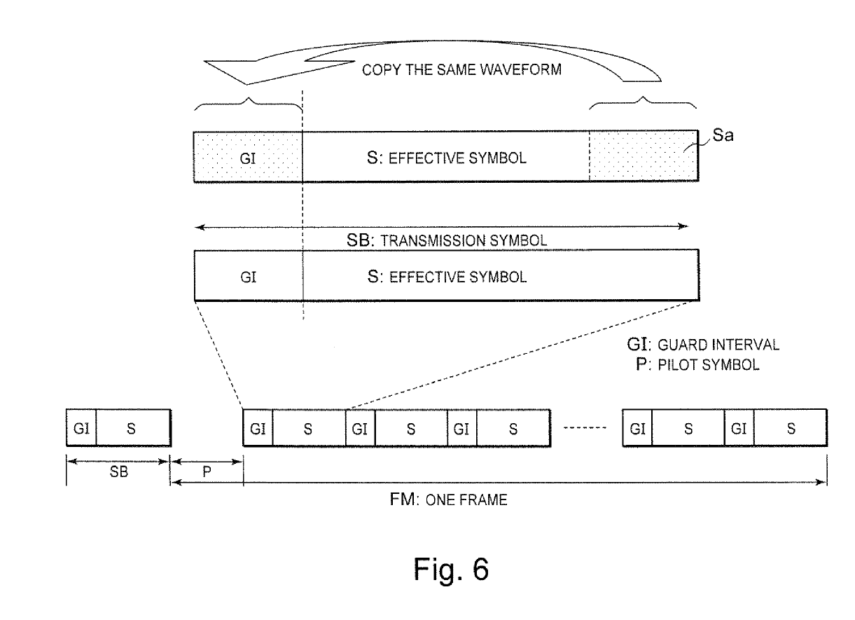

FIG. 7: A view of a general configuration diagram of the demodulation apparatus using the conventional OFDM method.

FIG. 8: A view of a diagram showing the relationship between the correlation window and the receiving signal of FIG. 7.

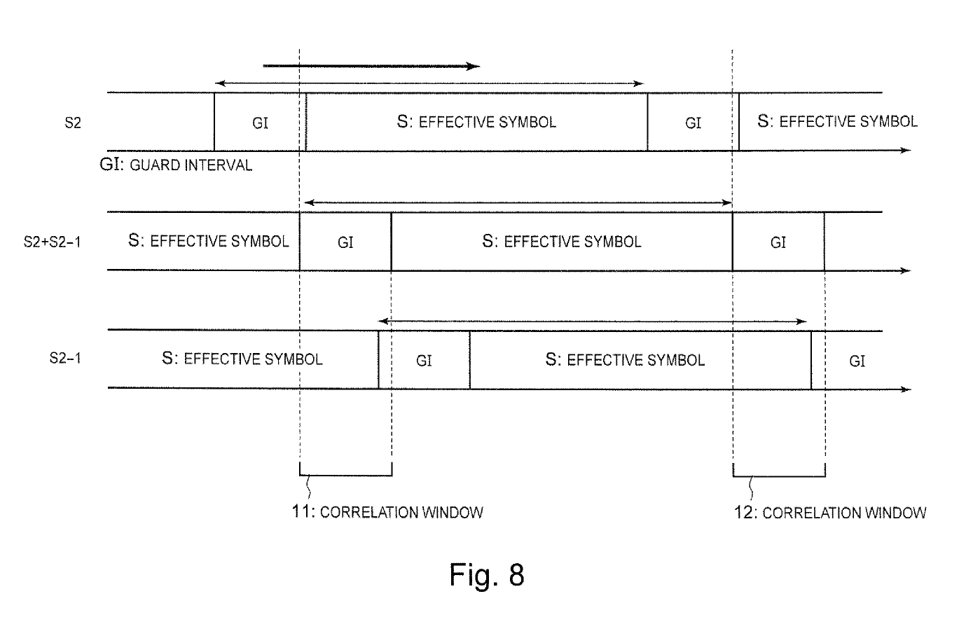

FIG. 9: A view of a diagram showing an example of the correlation output signal S10 of FIG. 7 in the case of one-path receiving.

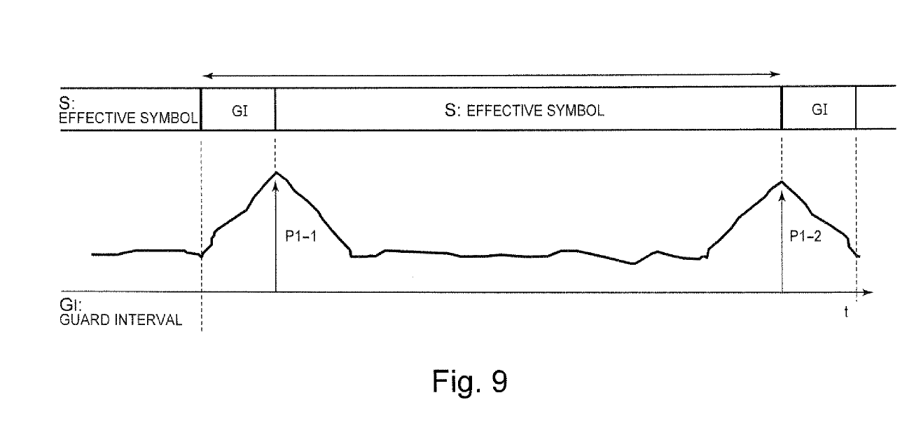

FIG. 10: A view of a diagram showing an example of the correlation output signal S10 of FIG. 7 in the case of two-path receiving.

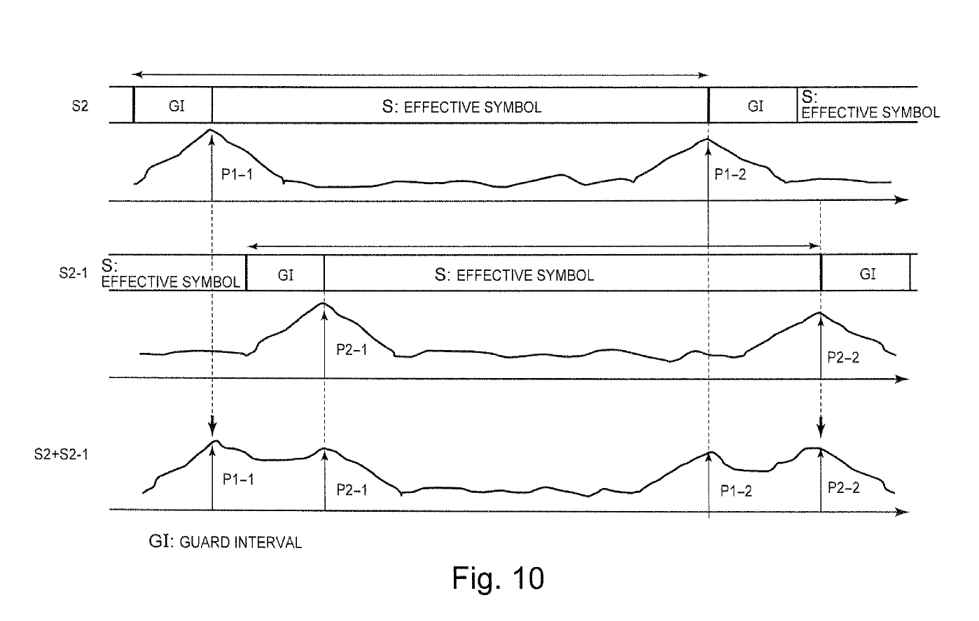

### DETAILED DESCRIPTION OF THE PREFERRED EMBODIMENTS

The correlator for FFT time synchronization includes the correlation value calculator and the adder. The correlation value calculator for FFT time synchronization calculates a plural of correlation values of different time locations by delaying the OFDM modulated receiving signal having the effective symbol added by the guard interval. The adder adds the above plural of correlation values calculated by the above correlation-value calculator and outputs the correlation output signal for FFT time synchronization.

### First Embodiment

### Configuration of the First Embodiment:

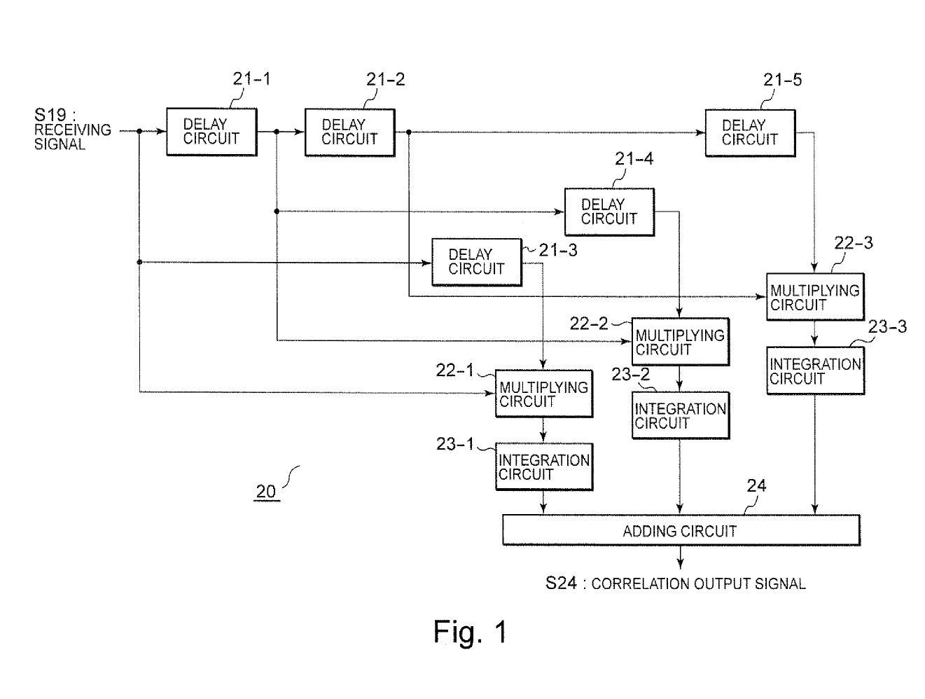

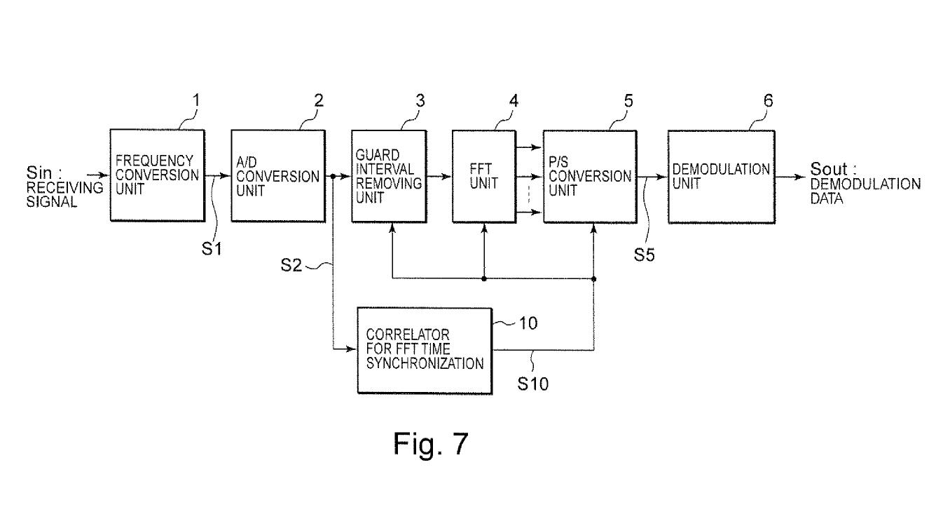

FIG. 1 is a view of general configuration diagram of a correlator for FFT time synchronization according to the first embodiment of the present invention. The above correlator 20 for FFT time synchronization is placed, for example, in a place corresponding to the correlator 10 in the conventional demodulator of FIG. 7, and includes a correlation value calculator for calculating a plural of correlation values having different time locations by delaying a receiving signal S19 corresponding to the base-band signal S2 of FIG. 7, an adder (for example, an adding circuit) 24 for outputting a correlation output signal S24 for FFT time synchronization by adding the plural of correlation values thereof. The above correlation value calculator consists of delay devices (for example, delay circuits configured by shift registers, etc.) 21-1-21-5 for delaying the receiving signal S19, multipliers (for example, multiplying circuits) 22-1-22-3 for multiplying the signal before being delayed and the delayed signal in the above delay circuits 21-1-21-5, and integration devices (for example, integration circuits) 23-1-23-3 for calculating the plural of correlation values having the same time intervals by integrating the multiplying results of the above multiplying circuits 22-1-22-3.

Each of the delay circuits 21-1 and 21-2 out of the delay circuits 21-1-21-5 has the same delay time length, and each of the delay circuits 21-3, 21-4, 21-5 has the delay time length of the effective symbol S. The above delay circuits 21-2, 21-2, 21-5 are serially connected to an input terminal for inputting the receiving signal S19. Furthermore, the delay circuit 21-3 is connected to the above input terminal, and at the same time the delay circuit 21-4 is connected to the output side of the delay circuit 21-1.

The multiplying circuit 22-1 is connected to the input terminal of the receiving signal S19 and the output side of the delay circuit 21-3. Furthermore, the multiplying circuit 22-2 is connected to the output sides of the delay circuits 21-1 and 21-4, and at the same time the multiplying circuit 22-3 is connected to the output sides of the delay circuits 21-2 and 21-5. The multiplying circuit 22-1 multiplies the input signal of the delay circuit 21-1 and the output signal of the delay circuit 21-3. The multiplying circuit 22-2 multiplies the input signal of the delay circuit 21-2 and the output signal of the delay circuit 21-4. And the multiplying circuit 22-3 multiplies the input signal of the delay circuit 21-3 and the output signal of the delay circuit 21-5.

Each of the integration circuits 23-1-23-3 is connected to each of the output sides of the multiplying circuits 22-1-22-3, respectively. Each of the integration circuits 23-1-23-3 integrates the output signals having the guard interval GI length from each of the multiplying circuits 22-1-22-3, and the adding circuit 24 is connected to the output sides of the above multiplying circuits. An adding circuit 24 adds the output signals of the integration circuits 23-1-23-3 and outputs the above adding result as the correlation output signal S24.

### Correlation Value Calculation Method of the First Embodiment:

According to the correlation value calculation method of the first embodiment in the correlator 20, when the receiving signal S19 is inputted, the receiving signal S19 is sequentially delayed by the delay circuits 21-1, 21-2, 21-5. Furthermore, the receiving signal S19 is delayed by the delay circuit 21-3, and the output signal of the delay circuit 21-1 is simultaneously delayed by the delay circuit 21-4. The receiving signal S19 and the output signal of the delay circuit 21-3 are multiplied by the multiplying circuit 22-1, and the output signals of the delay circuit 21-1 and the delay circuit 21-4 are multiplied by the multiplying circuit 22-2. Furthermore, the output signals of the multiplying circuit 21-2 and the multiplying circuit 21-5 are multiplied by the multiplying circuit 22-3.

The output signal of each of the multiplying circuits 22-1-22-3 is integrated by each of the integration circuits 23-1-23-3, respectively, and correlation values having different time locations (that is, three correlation values located at different time locations) is outputted. The above three correlation values are added to one correlation value by the adding circuit 24, and the above one correlation value is outputted as the correlation output signal S24.

As explained before, according to the correlation calculation method of the first embodiment of the invention, since the adding result is outputted as one correlation value by adding three correlation values having different time locations, a strong correlation appears in the midpoint between the main arriving path and the long-delayed path in the case where the long-delayed path having a power equivalent to the one of the main arriving path exists. Consequently, the state can be prevented in which strong correlations appear at both of arriving time locations of the main arriving path and the long-delayed path, similarly as in the conventional method, and then jitter of the time synchronization can be restrained.

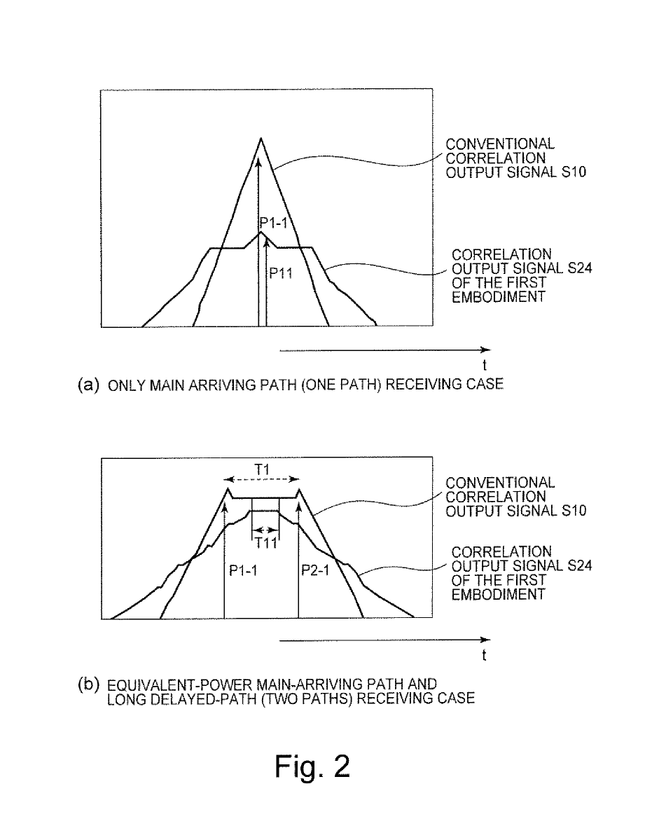

FIG. 2(a), (b) are views of conceptual diagrams of the correlation output signal S24 in FIG. 1. The above FIG. 2(a) is a view of comparison diagram between the conventional correlation output signal S10 of the case where only one path of the main arriving path is received and the output correlation signal S24 of the first embodiment of the present invention. In addition, the above FIG. 2(b) is a view of comparison diagram between the conventional correlation output signal S10 of the case where two paths of the main arriving path and the long-delayed path having the equivalent powers are received and the output correlation signal S24 of the first embodiment of the present invention.

As shown in FIG. 2(a), the correlation output signal S24 according to the first embodiment of the invention has the strongest correlation (the conventional maximum power P1-1, the maximum power P11 of the first embodiment) at the time location of the main arriving path in the case where only one path is received, similarly as in the conventional method, and then reliable receiving thereof becomes possible.

In addition, as shown FIG. 2(b), according to the first embodiment of the invention, each of the tracks of the correlation output signals S10, S24 has a table shape shorter than the long delay time having peaks located in the midpoint between the main arriving path and the long-delayed path in the case where two paths are received, similarly as in the conventional method. That is, strong correlations (the maximum power P1-1, P2-1) appear at each of the arriving time locations thereof, and then the tracks of the correlation output signal S10, S24 become table shape having two peaks located in the interval of the two-path delay time. In real communication according to the first embodiment of the invention, the height of the peaks varies by influences of the OFDM modulated signal waveform or the interference power component, similarly as in the conventional method, however, the time interval T11 between the peaks of the first embodiment is shorter than the time interval T1. Therefore, in the case where time synchronization of FFT input signal is done using the correlation output signal S24 of the first embodiment of the invention, the maximum correlation time location differential becomes smaller than in the case where the conventional correlation output signal S10 is used. Consequently, the time synchronization becomes stable and deterioration of receiving characteristics caused by ISI can be reduced.

### Effect of the First Embodiment:

According to the first embodiment of the present invention, there are effects as described in the following descriptions of (1), (2).
(1) As shown in FIG. 2, according to the first embodiment of the invention, the correlation output signal S24 of a waveform of a table-shape having the projected center is generated by delaying and adding OFDM symbols. Meanwhile, since the conventional correlation output signal S10 is generated by integrating only one OFDM symbol, the correlation output signal S10 has a simple table shape. As the correlation output signal S24 of the first embodiment, a signal waveform having a projected center is effective in the case where the number of OFDM signals is one or two. Consequently, according to the first embodiment of the invention, even during when the receiving signal S19 including long-delayed path having the equivalent power is received, the variation of the maximum correlation time location is small, and the FFT time synchronization becomes stable. Therefore, deterioration of the receiving characteristics caused by ISI can be reduced.
(2) In the case where the first embodiment of the invention is applied to, for example, digital terrestrial broadcasting, the characteristics of receiving two long-delayed paths (delay time) is improved by 20%.

### Second Embodiment

### Configuration of the Second Embodiment:

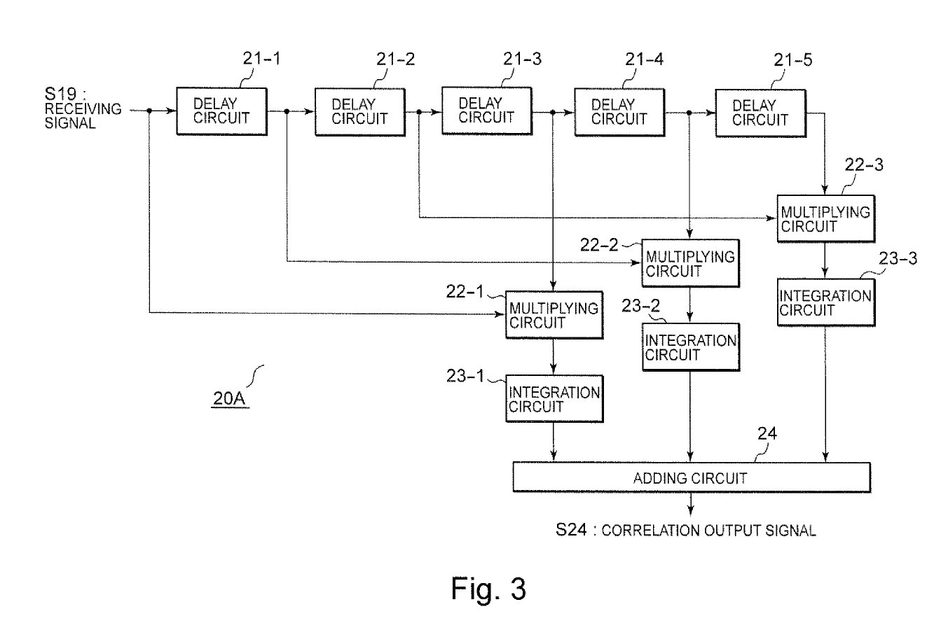

FIG. 3 is a view of general configuration diagram for time FFT time synchronization according to the second embodiment of the present invention, and the same numerals are given to the identical elements to ones in FIG. 1 according to the first embodiment.

A correlator 20A for FFT time synchronization of the second embodiment is configured with a reduced circuit volume compared with the delay circuit of the correlator of the first embodiment, and includes a delay circuits 21-1, 21-2, 21-4, 21-5 having the same delay time length, and the delay circuit 21-3 having a delay time length set so that the total delay time length of the delay circuits 21-1, 21-2 and 21-3 is the symbol S length.

Other than the above circuits, as in the first embodiment, a complex multiplying circuit 22-1 for complex multiplying the input signal of the delay circuit 21-1 and the output signal of the delay circuit 21-3; a complex multiplying circuit 22-2 for complex multiplying the input signal of the delay circuit 21-2 and the output signal of the delay circuit 21-4; and a complex multiplying circuit 22-3 for multiplying the input signal of the delay circuit 21-3 and the output signal of the delay circuit 21-5 are included therein. As in the first embodiment, each of the integration circuits 23-1-23-3 for integrating the input signal of guard interval length GI is connected to the output sides of the above multiplying circuits 23-1-23-3, respectively, and furthermore, a adding circuit 24 for outputting a correlation output signal S24 by adding the output signals thereof is connected to the output sides of the above multiplying circuits 23-1-23-3.

### Correlation Value Calculation Method of the Second Embodiment:

In a correlation value calculation method of the correlator 20A of the second embodiment, when a receiving signal S19 is received, the above receiving signal S19 is sequentially delayed by the delay circuits 21-1-21-5, and each of the above input and output signals is multiplied each other by the multiplying circuits 22-1-22-3, as in the first embodiment, and the multiplying results thereof are integrated by the integration circuits 23-1-23-3 to calculate three correlation values. Subsequently, the above three correlation values are added to one correlation value, and the one correlation value thereof is outputted as the correlation output signal S24.

As explained before, the second embodiment of the invention is configured with the reduced circuit volume compared with the delay circuit of the first embodiment, however, the correlation value calculation method is done approximately similarly as in the first embodiment. Consequently, as in the conventional correlator 10 of FIG. 7, the integration circuit 23-1 operates so that the total delay time length of the delay circuits 21-1, 21-2, and 21-3 becomes the effective symbol S length in order to correlate in the same way as the conventional correlator. Similarly, the integration circuit 23-2 operates so that the total delay time length of the delay circuits 21-2, 21-3, and 21-4 becomes the effective symbol S length in order to correlate the receiving signal S19 having the length of the guard interval GI delayed by the effective symbol S length, and the integration circuit 23-3 operates so that the total delay time length of the delay circuits 21-3, 21-4, and 21-5 becomes the effective symbol S length in order to correlate in the same way as the conventional correlator. By the above operations, three correlation values delayed by the delay time length of the delay circuit 21-1 (and the delay circuits 21-2, 21-4, 21-5) are calculated by the integration circuits 23-1-23-3.

### Effect of the Second Embodiment:

According to the second embodiment of the invention, the circuit volume of the delay circuit can be reduced compared with the delay circuit of the first embodiment, and there is the same effect as the effects (1), (2) of the first embodiment.

### Third Embodiment

### Configuration of the Third Embodiment:

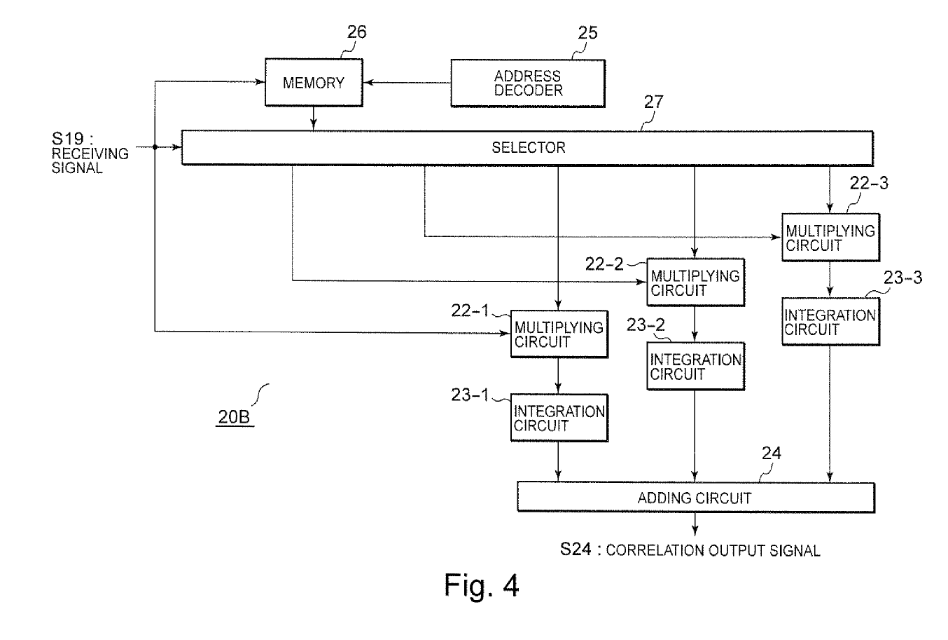

FIG. 4 is a view of a general configuration diagram of a correlator for FFT time synchronization according to the third embodiment of the invention. The same numerals are given to the identical elements to ones in FIG. 1 according to the first embodiment.

A correlator 20B for FFT time synchronization according to the third embodiment includes a delay device consisting of an address decoder 25, a memory 26, and a selector 27, instead of the delay circuits 21-1-21-5 of the correlator 20 according to the first embodiment. The address decoder 25 is configured to be able to adjust the delay time interval of the outputs from the memory 26 for storing the receiving signal S19 by changing the generated address value thereof. The selector 27 changes the connection point of the output signal corresponding to each of the delay times.

The multiplying circuits 22-1-22-3 are connected to the input and output sides of the above selector 27, and furthermore, the adding circuit 24 is connected to the output sides of the above multiplying circuits through the intermediary of the integration circuits 23-1-23-3.

### Correlation Value Calculation Method of the Third Embodiment:

The correlator 20B according to the third embodiment of the invention is configured by the memory 26, etc. instead of the delay circuits 21-1-21-5 of the first embodiment, however, the correlation value calculation method is done in the approximately same way as in the first embodiment.

In other words, the above correlation value method is done so that the output signal from the memory 26 for storing the receiving signal S19 has the same time relationship as in the first embodiment. The current receiving signal S19 and the receiving signal delayed by time length of the effective symbol S are used as the input signals of the multiplying circuit 22-1. The receiving signal delayed by the same delay time as in the delay circuit 21-1 of the first embodiment (and the delay circuit 21-2); and the receiving signal delayed by delay time of adding the delay time of the delay circuit 21-1 of the first embodiment and the time length of the effective symbol S are used as the input signals of the multiplying circuit 22-2. The receiving signal delayed by delay time two times as long as the delay circuit 21-1 of the first embodiment (and the delay circuit 21-2); and the receiving signal delayed by delay time of adding the delay time two times as long as the delay circuit 21-1 of the first embodiment and the time length of the effective symbol S are used as the input signals of the multiplying circuit 22-3. By the above-mentioned method, the approximately same operation as in the first embodiment can be conducted.

In the correlator 20B, for example, the number of shift registers composing the delay circuit can be reduced by configuration of the delay device by a memory, and then lowering power consumption and downsizing thereof becomes possible. In addition, the delay time interval between the three correlation value outputs become changeable by changing the address of the output from the memory 26 generated by the address decoder 25, and therefore, the changing thereof makes it possible that the correlation output value having less time jitter.

### Effect of the Third Embodiment:

According to the third embodiment of the invention, there are similar effects as the effects (1), (2) of the first embodiment. Furthermore, the following effect can be achieved, other than the above effects.
(3) By changing the output address from the memory 26 generated by the address decoder 25, the delay time interval can be changed to lessen the variation of the time location of the maximum correlation thereof.

### Fourth Embodiment

### Configuration of the Fourth Embodiment:

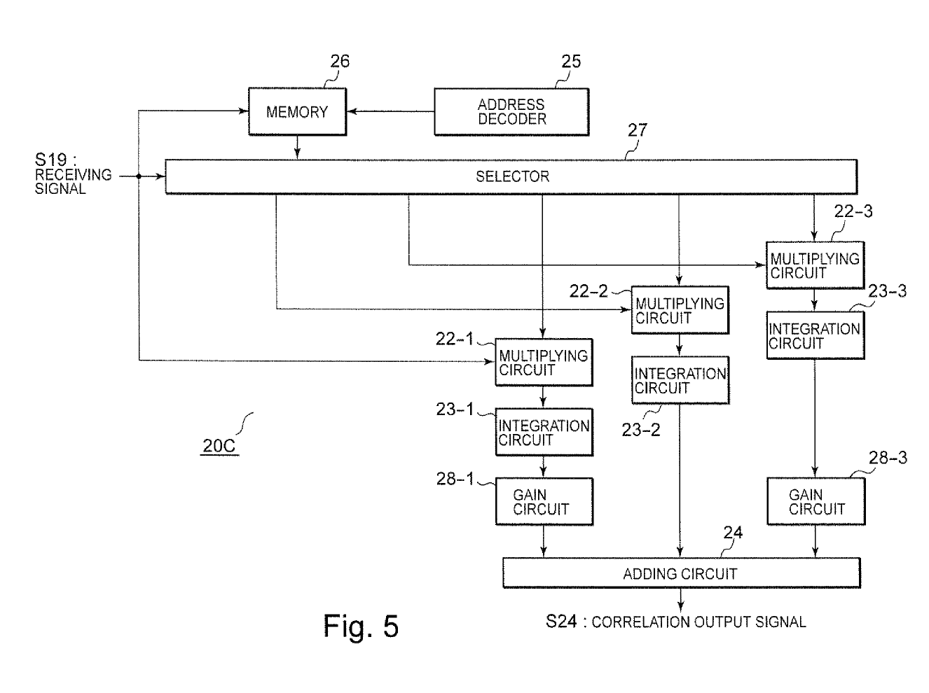

FIG. 5 is a view of a general configuration diagram of a correlator for FFT time synchronization according to the fourth embodiment of the invention, and the same numerals as in FIG. 4 are given to the identical elements to ones in FIG. 4 of the third embodiment.

The correlator 20C according to the fourth embodiment of the invention includes an address 25, a memory 26 for storing a receiving signal S19, a selector 27 for changing the connection points of the outputs from the above memory 26 corresponding to the delay time of each of the above outputs, multiplying circuits 22-1-22-3 for complex multiplying the output and input signals from the above selector 27, and integrated circuits 23-1-23-3 for integrating input signal having the guard interval GI length, as the correlator 20B according to the third embodiment.

The difference of the fourth embodiment of the invention from the third embodiment is that weighting devices (for example, a gain circuit), 28-1, 28-3 are newly connected to the output sides of the integration circuits 23-1-23-3, and an adder 24 same as in the third embodiment is connected to the output sides of the above the weighting devices, as in the third embodiment. There is a configuration that the gain circuit 28-1 multiply the output integration value from the integration circuit 23-1 by a changeable constant, the gain circuit 28-3 multiply the output integration value from the integration circuit 23-3 by a changeable constant, and the outputs from the above gain circuits 28-1, 28-3 and the output signal from the above integration circuit 23-2 are added each other by the adder 24 and the adding result thereof is outputted as a correlation output signal S24.

### Correlation Value Calculation Method According to the Fourth Embodiment:

The correlation value calculation method of the correlator 20C according to the fourth embodiment is done in the approximately same way as in the third embodiment. The different operation from the third embodiment is that two correlation values calculated by the integration circuits 23-1, 23-3 out of the three delayed correlation values calculated by the integration circuits 23-1-23-3 are weighted by the gain circuits 28-1, 28-3. The jitter of the maximum correlation time location caused by the delayed waves can be changed by changing the multiplying constants of the gain circuits 28-1, 28-3, and then the correlation result can be changed to the one having the smallest jitter.

### Effect of the Fourth Embodiment:

According to the fourth embodiment of the invention, there are the same effects as the effects (1), (2) of the first embodiment and the effect (3) of the third embodiment. Furthermore, the following effect can be achieved, other than the above effects.
(4) A correlation value output gain can be changed so that the variation of the time location of the maximum correlation becomes smaller by multiplying two correlation value outputs except the correlation value located in the time center by a constant using the gain circuits 28-1, 28-3.

### MODIFICATION EXAMPLE

The present invention is not limited to the above first embodiment to the above fourth embodiment, and various applications and modifications are possible. The examples of applications and modifications thereof are as follows.

The configuration of the correlator according to the embodiment of the correlation value calculation method of the invention is not limited to the configuration shown in the drawings, and can be changed to another circuit configuration. For example, the delay devices of FIG. 4 and FIG. 5 can be configured only by the memory 26, or only by the address decoder 31 and memory 26, or by the circuits including additional circuit to the above circuits.

### INDUSTRIAL AVAILABILITY

The correlation value calculating method and the correlator using the method thereof of the present invention is not limited to digital terrestrial broadcasting, and is applicable to all systems using OFDM modulation, and improvements of the above systems are strongly possible.

What is claimed is:

1. A correlation value calculation method being characterized by comprising;
a step for calculating a plural of correlation values located different time locations by delaying receiving OFDM modulated signals having effective symbols added by guard intervals; and
a step for generating a correlation output signal for FFT time synchronization by adding said plural of correlation values each other.

2. The correlation value calculation method according to claim 1, wherein said plural of correlation values are added after being weighted.

3. The correlation value calculation method according to any of claim 1, wherein the number of said plural of correlation values is three.

4. A correlator being characterized by comprising;
a correlation value calculation means for calculating a plural of correlation values located different time locations by delaying receiving OFDM modulated signals having effective symbols added by guard intervals; and
an adding means for adding said plural of correlation values each other and outputting a correlation output signal for FFT time synchronization.

5. The correlator according to claim 4, being characterized by further comprising;
a weighting means for weighting said plural of correlation values calculated by said correaltion value calculation means and making said adding means add said plural of weighted correlation values.

6. The correlator according to any of claim 4, wherein said correlation value calculation means comprises
a multiplying means for multiplying a not-delayed receiving signal and a delayed signal in said delaying means,
a integration means for integrating the multiplying results of said multiplying means and getting said plural of correlation values having a constant delay time interval between each other.

7. The correlator according to claim 6, wherein said delay means comprises a plural of delay circuits.

8. The correlator according to claim 6, wherein said delay means includes a memory for storing said receiving signal, and outputting said receiving signal by delaying said receiving signal by a required delay time.

9. The correlator according to claim 6, wherein said delay means comprises
a memory for storing said receiving signal and delaying said receiving signal by a required delay time, and
an address decoder for making the delay time interval between outputs from said memory changeable by changing generated address values.

10. The correlator according to any of claims 5, wherein said weighting means comprises a gain circuit for multiplying a constant.

11. The correlator according to any of claims 5, wherein the number of said plural of correlation values is three.

12. The correlator according to claim 11, wherein said weighting means comprises two gain circuits for multiplying two correlation values except one correlation value located in the time center out of said three correlation values by a constant.
